(19) United States
(12) Patent Application Publication
(10) Pub. No.: US 2016/0168424 A1
(43) Pub. Date: Jun. 16, 2016

(54) LINERLESS SHEETING ARTICLE

(71) Applicant: 3M INNOVATIVE PROPERTIES COMPANY, Minnesota, MN (US)

(72) Inventors: Aniket N/A, New Delhi (IN); Jitendra S. Rathore, Woodbury, MN (US); Gaurav Manik, Muzaffarnagar (IN); Suresh Iyer, Woodbury, MN (US)

(73) Assignee: 3M Innovative Properties Company, St. Paul, MN (US)

(21) Appl. No.: 14/907,066

(22) PCT Filed: Aug. 30, 2013
(86) PCT No.: PCT/IN2013/000534

§ 371 Date: Jan. 22, 2016

(51) Int. Cl. C09J 7/02; C09D 129/04

(52) U.S. Cl. CPC C09J 7/0217; C09D 129/04; C09J 2433/00; C09J 2429/00; C09J 2201/606

(57) ABSTRACT

Presently described are linerless sheeting articles comprising a substrate, a pressure sensitive adhesive layer disposed on the substrate, and a water soluble protective layer disposed on the pressure sensitive adhesive layer. The water soluble protective layer comprises at least 50 wt-% solids of a water soluble polymer and a polymer additive comprising a fluorinated-group, a silane group, or a combination thereof. The polymer additive is typically present in an amount no greater than 5 wt-% solids. In a favored embodiment, the polymer additive is an oligomer. Methods of making and applying the sheeting article are also described.

### SUMMARY

Presently described are linerless sheeting articles comprising a substrate, a pressure sensitive adhesive layer disposed on the substrate, and a water soluble protective layer disposed on the pressure sensitive adhesive layer. The water soluble protective layer comprises at least 50 wt-% solids of a water soluble polymer and a polymer additive comprising a fluorinated-group, a silane group, or a combination thereof. The polymer additive is typically present in an amount no greater than 5 wt-% solids. In a favored embodiment, the polymer additive is an oligomer.

In another embodiment, a method of making a sheeting article is described comprising providing a sheeting article comprising a substrate, a pressure sensitive adhesive layer disposed on the substrate, and a release liner disposed on the pressure sensitive adhesive layer. The method further comprises removing the release liner; applying an aqueous coating composition comprising a water soluble polymer and a polymer additive comprising a fluorinated-group, a silane group, or a combination thereof; and drying the aqueous coating composition.

In yet another embodiment, a method of applying a sheeting article is described comprising providing a linerless sheeting article as described herein, applying an aqueous solution to remove the water soluble protective coating; contacting the pressure sensitive adhesive layer to a surface; and applying pressure to remove the aqueous solution between the pressure sensitive adhesive layer and the surface.

### DESCRIPTION OF THE DRAWINGS

FIG. 1 is a cross-sectional view of an embodied sheeting article;

FIG. 2A is a cross-sectional view of a conventional sheeting article comprising a microstructured surface prior to application of a water soluble protective layer;

FIG. 2B is a cross-sectional view of a conventional sheeting article comprising a microstructured surface after application of a water soluble protective layer.

### DETAILED DESCRIPTION

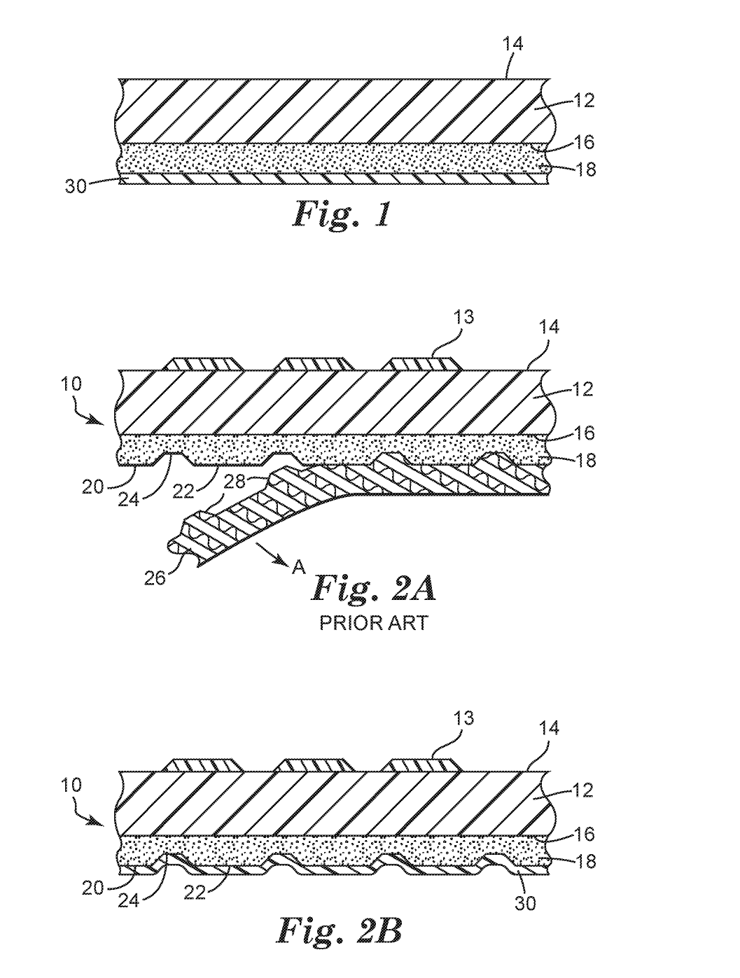

Presently described are linerless sheeting articles. With reference to FIG. 1, the sheeting article 100 generally comprises (e.g. film) substrate 12; a pressure sensitive adhesive layer 18 disposed on the (e.g. film) substrate, and a water soluble protective layer 30 disposed on the pressure sensitive adhesive layer 18. The sheeting typically further comprises a printed graphic or decorative pattern printed on the exposed surface 14 of the substrate. Alternatively or in combination thereof, the sheeting may comprise a printed graphic or decorative pattern on the opposing surface of the substrate 16 such that the printed graphic or decorative pattern is buried between the (e.g. film) substrate 12 and pressure sensitive adhesive layer 18.

The water soluble protective layer is utilized in place of a conventional (e.g. silicone) release liner. Hence, the sheeting article is linerless, lacking a release liner. Omitting the release liner can advantageously reduce waste and reduce cost.

The water soluble protective layer is capable of being easily dissolved by or dispersed by water. Hence, the term “water soluble” is inclusive of “water dispersible” unless specified otherwise. By easily dissolved or dispersed it is meant that the water soluble protective layer is substantially removed when rinsed with tap water for 5 minutes at a distance of 25 cm below a faucet, the flowing water temperature ranging from 45° F. (7.2° C.) to 68° F. (e.g. 20° C.) rate at a water flow rate of 1-1.5 kg/minute. In some embodiments, the water temperature is 20° C.

When the water soluble protective layer is substantially removed and the composition of the water soluble protective coating does not detract from the peel adhesion properties, the pressure sensitive adhesive layer exhibits a change (e.g. decrease) in initial peel adhesion of no greater than 15% as compared to the same pressure sensitive adhesive layer in the absence of the water soluble protective coating being applied to the adhesive layer and removed. In favored embodiments, as exemplified herein, the pressure sensitive adhesive layer exhibits a change (e.g. decrease) in initial peel adhesion of no greater than 10%. In some embodiments, the pressure sensitive adhesive layer exhibits a change (e.g. increase) in aged peel adhesion of no greater than 5, 10, or 15%. As used herein, initial and aged peel adhesion refers to the peel adhesion values obtained according to the test methods described in the forthcoming examples. In one embodiment, the aging conditions are 40° C. and 75% relative humidity for 24 hours. In another embodiment, the aging conditions are 50° C. and 98% relative humidity for 24 hours.

The water soluble protective layer comprises a water soluble organic polymer and a minor amount of a polymer additive comprising a fluorinated group, a silane group, or a combination thereof. It has been found that a small concentration of such polymer additive can prevent a reduction in peel adhesion. Without intending to be bound by theory, it is surmised that the inclusion of the polymer additive inhibits moisture absorption of the water soluble organic polymer. Such moisture absorption is surmised to cause the reduction in peel adhesion and can be detected by use of Fourier transform infrared (FTIR) spectroscopy. In one embodiment, upon removing the water soluble protective layer, the adhesive of the linerless sheeting article exhibits little or no change in the absorption peak nearest 3500 cm⁻¹ after aging at 40° C. and 75% relative humidity for 24 hours. For example, the difference in the height of the absorption peak nearest 3500 cm⁻¹ may range from zero to no greater than 0.015.

Unless specified otherwise term “polymer”, with regard to the water soluble organic polymer as well as the polymer additive, refers to both oligomers having 2 to 20 repeat units, as well as higher molecular weight polymers having greater than 20 repeat units.

The molecular weight of the water soluble polymer can vary. Water soluble polymers typically have a molecular weight up to about 500,000 g/mole. Lower molecular weight water soluble polymers can be easier to remove with water. In some embodiments, the molecular weight of the water soluble polymer is at least 1000 g/mole, 5000 g/mole, or 10,000 g/mole and typically no greater than 100,000 g/mole, or 50,000 g/mole, or 25,000 g/mole. Mixtures of two different molecular weight polymers can be utilized.

The water soluble protective layer comprises an organic polymer containing polar groups, rendering the polymer soluble in water. Water soluble polymers are typically grouped by the chemistry of their structure. Various water soluble polymers are known. In some embodiments, the water soluble polymer is a poly(alkylene oxide) polymer and in particular a polymer comprising ethylene oxide repeat units, optionally in combination with propylene oxide repeat units. In other embodiments, the hydrophilic polymers comprise hydroxyl groups such as in the case of polyvinyl alcohol (PVA); carboxyl methyl cellulose and (e.g. sodium) salts thereof; and polyvinylpyrrolidone. Bio-based water soluble polymers include gelatin and polysaccharides such as starch or dextrin. The water soluble protective coating typically comprises at least 50 wt-% solids of water soluble polymer. In some embodiments, the water soluble protective coating comprises at least 60, 70, 80, or 90 wt-% solids or greater of water soluble polymer. Mixtures of two different water soluble polymers (e.g. having different polar groups) can be utilized.

The water soluble protective layer comprises a polymer additive in an amount of at least 0.1, 0.2, 0.3, 0.4 or 0.5 wt-% solids of the dried water soluble protective coating composition and typically no greater than 10, 9, 8, 7, 6, 5, 4, 3, or 2 wt-%. Typically, the minimal concentration of polymer additive that prevents a change in (e.g. initial and/or aged) peel adhesion is utilized.

In one embodiment, the water soluble protective layer comprises an additive that is an oligomer. For example, a urethane oligomer can be prepared from one or more polyfunctional isocyanate compounds in combination with one or more polyols. The fluorinated group, silane group, or combination thereof can be incorporated into the oligomer by use of monofunctional compounds such as fluorochemical monoalcohols or silanes having one or more alkoxy group. By use of monofunctional compounds, the oligomer includes a terminal group that is a perfluorinated monovalent group (R_{f}), an alkoxy silane group, or a combination thereof.

Perfluorinated monovalent groups (R_{f}) of the oligomer additive may be perfluoroalkyl and perfluoroheteroalkyl, and perfluorinated divalent groups may be perfluoroalkylene and perfluoroheteroalkylene. Perfluoroalkyl groups are preferred, with perfluoroalkyl groups having from 2 to 6 carbon atoms being more preferred and perfluoroalkyl groups having 4 carbon atoms being most preferred. Another embodiment comprises perfluoroheteroalkyl groups having 6 to 50 carbon atoms. Perfluorinated divalent groups are preferably perfluoroheteroalkylene groups. Perfluoroheteroalkylene groups are preferably perfluoropolyether groups having from about 3 to about 50 carbon atoms.

Fluorochemical monoalcohols suitable for use in preparing the (e.g. oligomer) polymer additive comprise at least one R_{f} group. The R_{f} groups can contain straight-chain, branched-chain, or cyclic fluorinated alkylene groups or any combination thereof. The R_{f} groups can optionally contain one or more heteroatoms (i.e. oxygen, sulfur, and/or nitrogen) in the carbon-carbon chain so as to form a carbon-heteroatom-carbon chain (i e a heteroalkylene group). Fully-fluorinated groups are generally preferred, but hydrogen or chlorine atoms can also be present as substituents, provided that no more than one atom of either is present for every two carbon atoms. It is additionally preferred that any R_{f} group contain at least about 40% fluorine by weight, more preferably at least about 50% fluorine by weight. The terminal portion of the group is generally fully-fluorinated, preferably containing at least three fluorine atoms, e.g., CF₃O—, CF₃CF₂—, CF₃CF₂CF₂—, ((CF₃)₂CF—, SF₅CF₂—. Perfluorinated aliphatic groups (i.e., those of the formula CₙF₂ₙ₊₁—) wherein n is 2 to 6 inclusive are the preferred R_{f} groups, with n=3 to 5 being more preferred and with n=4 being the most preferred.

Useful fluorine-containing monoalcohols include compounds of the following formula:

R_{f}—Z—R²—OH

wherein: R_{f} is a perfluoroalkyl group or a perfluoroheteroalkyl group as defined above; Z is a connecting group selected from a covalent bond, a sulfonamido group, a carboxamido group, a carboxyl group, or a sulfinyl group; and R² is a divalent straight- or branched-chain alkylene, cycloalkylene, or heteroalkylene group of 1 to 14 carbon atoms, preferably 1 to 8 carbon atoms, more preferably 1 to 4 carbon atoms, and most preferably two carbon atoms. Representative examples of useful fluorine-containing monoalcohols include CF₃(CF₂)SO₂N(CH₃)CH₂CH₂OH as well as various other known fluorine-containing monoalcohols as described in U.S. Pat. No. 8,030,430 and U.S. Pat. No. 6,646,088; incorporated herein by reference.

The silane group of the oligomer additive are typically derived from a silane compound of the following formula:

X—R¹—Si—(Y)₃

wherein: X is —NH²; —SH; —OH; or —NRH where R is a phenyl, straight or branched aliphatic, alicyclic, or aliphatic ester group; R¹ is an alkylene, heteroalkylene, aralkylene, or heteroaralkylene bridging group; and each Y is independently a hydroxyl; a hydrolyzable moiety selected from the group consisting of alkoxy, acyloxy, heteroalkyoxy, heteroacyloxy, halo, and oxime; or a non-hydrolyzable moiety selected from the group consisting of phenyl, alicyclic, straight-chain aliphatic, and branched-chain aliphatic, wherein at least one Y is a hydrolyzable moiety such as a C₁-C₄ alkoxy group and preferably a C₁-C₂ alkoxy.

The silane groups of the diol may contain one, two, or three hydrolyzable groups on the silicon atom. Polyalkylsiloxane diols include, but are not limited to, hydroxyalkyl terminated polydimethyl siloxanes, polymethyloctadecylsiloxane, polydimethylmethyloctadecylsiloxane, polydimethyldodecyltetradecylsiloxane, polymethylhexadecylsiloxane, polymethyloctylsiloxane, polymethyl-3,3,3-trifluoropropylsiloxane, and the like. Polyarylsiloxane diols are essentially the same as the polyalkylsiloxanes with some or all of the methyl groups replaced with phenyl groups, such as hydroxyalkyl terminated polydiphenylsiloxane and hydroxyalkyl terminated dimethyl-diphenylsiloxane copolymer.

Polyfunctional isocyanate compounds useful for preparing the oligomer additive comprise isocyanate radicals attached to the multi-valent organic group that can comprise a multi-valent aliphatic, alicyclic, or aromatic moiety; or a multi-valent aliphatic, alicyclic or aromatic moiety attached to a biuret, an isocyanurate, or a uretdione, or mixtures a, thereof. Preferred polyfunctional isocyanate compounds contain two or three —NCO radicals. Compounds containing two —NCO radicals are comprised of divalent aliphatic, alicyclic, araliphatic, or aromatic moieties to which the —NCO radicals are attached. Preferred compounds containing three —NCO radicals are comprised of isocyanatoaliphatic, isocyanatoalicyclic, or isocyanatoaromatic, monovalent moieties, which are attached to a biuret or an isocyanurate.

In some embodiments, the polyisocyanate is an aliphatic compound. Examples of useful aliphatic polyfunctional isocyanate compounds include, but are not limited to, those selected from the group consisting of 1,4-tetramethylene diisocyanate; hexamethylene 1,4-diisocyanate; hexamethylene 1,6-diisocyanate (HDI); 1,12-dodecane diisocyanate, 2,2,4-trimethyl-hexamethylene diisocyanate (TMDI); 2,4,4-trimethyl-hexamethylene diisocyanate; 2-methyl-1,5-pentamethylene diisocyanate dimer diisocyanate; the urea of hexamethylene diisocyanate; the biuret of hexamethylene 1,6-diisocyanate; (available as “DESMODUR N-100” and DESMODUR N-3200″ from Bayer Corporation, Pittsburgh, Pa.), the isocyanurate of HDI (available as “DESMODUR N-3300” and “DESMODUR N-3600” from Bayer Corporation, Pittsburgh, Pa.), a blend of the isocyanurate of HDI and the uretdione of HDI (available as DESMODUR “N-3400” available from Bayer Corporation, Pittsburgh, Pa.), and mixtures thereof.

Examples of useful alicyclic polyfunctional isocyanate compounds include, but are not limited to, those selected from the group consisting of dicyclohexylmethane diisocyanate (commercially available as “DESMODUR W”, available from Bayer Corporation, Pittsburgh, Pa.); 4,4′-isopropyl-bis(cyclohexylisocyanate); isophorone diisocyanate (IPDI); cyclobutane-1,3-diisocyanate; cyclohexane 1,3-diisocyanate; cyclohexane 1,4-diisocyanate (CHDI); 1,4-cyclohexanebis(methylene isocyanate) (BDI); 1,3-bis(isocyanatomethyl)cyclohexane; 3-isocyanatomethyl-3,5,5-trimethylcyclohexyl isocyanate; and mixtures thereof.

Preferred polyisocyanates include hexamethylene 1,6-diisocyanate (HDI); 1,12-dodecane diisocyanate isophorone diisocyanate; toluene diisocyanate; dicyclohexylmethane 4,4′diisocyanate; MDI, and derivatives of all the aforementioned.

Polyols suitable for use in preparing the oligomer additive include those organic polyols that have an average hydroxyl functionality of at least about 2 (preferably, about 2 to 5; more preferably, about 2 to 3; most preferably, about 2, as diols are most preferred). The hydroxyl groups can be primary or secondary, with primary hydroxyl groups being preferred for their greater reactivity. Mixtures of diols with polyols (e.g. triols) that have an average hydroxyl functionality of about 2.5 to 5 (preferably about 3 to 4; more preferably, about 3) can also be used. In some embodiments, the reaction mixture of the oligomer additive contains no more than about 20, 10 or 5 percent by weight of such polyols.

Representative examples of suitable non-polymeric polyols include alkylene glycols, polyhydroxyalkanes, and other polyhydroxy compounds.

The alkylene glycols include, for example, 1,2-ethanediol; 1,2-propanediol; 3-chloro-1,2-propanediol; 1,3-propanediol; 1,3-butanediol; 1,4-butanediol; 2-methyl-1,3-propanediol; 2,2-dimethyl-1,3-propanediol (neopentylglycol); 2-ethyl-1,3-propanediol; 2,2-diethyl-1,3-propanediol; 1,5-pentanediol; 2-ethyl-1,3-pentanediol; 2,2,4-trimethyl-1,3-pentanediol; 3-methyl-1,5-pentanediol; 1,2-, 1,5-, and 1,6-hexanediol; 2-ethyl-1,6-hexanediol; bis(hydroxymethyl)cyclohexane; 1,8-octanediol; bicyclo-octanediol; 1,10-decanediol; tricyclo-decanediol; norbomanediol; and 1,18-dihydroxyoctadecane.

The polyhydroxyalkanes include, for example, glycerine; trimethylolethane; trimethylolpropane; 2-ethyl-2-(hydroxymethyl)-1,3-propanediol; 1,2,6-hexanetriol; pentaerythritol; quinitol; mannitol; and sorbitol.

The other polyhydroxy compounds include, for example, such as di(ethylene glycol); tri(ethylene glycol); tetra(ethylene glycol); tetramethylene glycol; dipropylene glycol; diisopropylene glycol; tripropylene glycol; bis(hydroxymethyl)propionic acid; N,N-bis(2-hydroxyethyl)-3-aminopropyltriethoxysilane; bicine; N-bis(2-hydroxyethyl) perfluorobutylsulfonamide; 1,11-(3,6-dioxaundecane)diol; 1,14-(3,6,9,12-tetraoxatetradecane)diol; 1,8-(3,6-dioxa-2,5,8-trimethyloctane)diol; 1,14-(5,10-dioxatetradecane)diol; castor oil; 2-butyne-1,4-diol; N,N-bis(hydroxyethyl)benzamide; 4,4′-bis(hydroxymethyl)diphenylsulfone; 1,4-benzenedimethanol; 1,3-bis(2-hydroxyethyoxy)benzene; 1,2-dihydroxybenzene; resorcinol; 1,4-dihydroxybenzene; 3,5-, 2,6-, 2,5-, and 2,4-dihydroxybenzoic acid; 1,6-, 2,6-, 2,5-, and 2,7-dihydroxynaphthalene; 2,2′- and 4,4′-biphenol; 1,8-dihydroxybiphenyl; 2,4-dihydroxy-6-methyl-pyrimidine; 4,6-dihydroxypyrimidine; 3,6-dihydroxypyridazine; bisphenol A; 4,4′-ethylidinebisphenol; 4,4′-isopropylidenebis(2,6-dimethylphenol); bis(4-hydroxyphenyl)methane; 1,1-bis(4-hydroxyphenyl)-1-phenylethane (bisphenol C); 1,4-bis(2-hydroxyethyl)piperazine; bis(4-hydroxyphenol) ether; 1,4-bis(1-hydroxy-1,1-dihydroperfluoroethoxyethoxy) perfluoro-n-butane; 1,4-bis(1-hydroxy-1,1-dihydroperfluoropropoxy) perfluoro-n-butane; as well as other aliphatic, heteroaliphatic, saturated alicyclic, aromatic, saturated heteroalicyclic, and heteroaromatic polyols; and the like, and mixtures thereof.

Various polymeric polyols are also known, several of which are described in previously cited U.S. Pat. No. 8,030,430 and U.S. Pat. No. 6,646,088.

The reaction mixture of the oligomer additive may further comprise a water-solubilizing compound, particularly when the other components of the reaction mixture are not sufficiently water soluble such that the oligomer additive can be dispersed in an aqueous solution with the water soluble polymer. The water-solubilizing compounds can be represented in general by “W—R¹—X,” wherein W is one or more water-solubilizing groups, X is an isocyanate-reactive group such as —NH₂; —SH; —OH; or —NRH, where R is a phenyl, straight or branched aliphatic, alicyclic, or aliphatic ester group; and R¹ is an alkylene, heteroalkylene, aralkylene, or heteroaralkylene group. A representative diol with a solubilizing group is 2,2-bis(hydroxymethyl)propionic acid and its salts such as its ammonium salt. A representative monoalcohol with a solubilizing group is glycolic acid (HOCH₂COOH) and its salts. Other solubilizing compounds are know from previously cited U.S. Pat. No. 8,030,430 and U.S. Pat. No. 6,646,088.

The reaction mixture of the oligomer additive may further comprise one or more stabilizers comprising one or more reactive groups as described in previously cited U.S. Pat. No. 8,030,430. Stabilizers that are useful include, for example, ultraviolet (UV) absorbers and hindered amine light stabilizers that comprise isocyanate-reactive groups that enable covalent incorporation into the polyurethane. Such reactable stabilizers can comprise, for example, one or more isocyanate-reactive groups such as amine, hydroxyl or similar groups. Reactable stabilizers comprise hydroxyl groups. Preferred UV absorbers include, for example, Tinuvin™ 405 and Tinuvin™ 1130. Hindered amine light stabilizers (HALS) function by inhibiting degradation of the binder in coatings, which has already formed free radicals. An example of a suitable reactable HALS is CGL-052.

In a favored embodiment, the urethane oligomer additive comprises at least two repeating units selected from the group consisting of fluorine-containing urethane oligomers and long-chain hydrocarbon-containing urethane oligomers. These urethane oligomers can comprise the reaction product of (a) one or more polyfunctional isocyanate compounds; (b) one or more polyols; (c) one or more monoalcohols selected from the group consisting of fluorochemical monoalcohols, and (d) one or more silanes. Such urethane oligomers may optionally further comprise the reaction product of substituted long-chain hydrocarbon monoalcohols, one or more water-solubilizing compounds, one or more stabilizers comprising one or more reactive groups, as previously described, as well as combinations of such compounds.

Long chain alkyl group can be derived from long chain hydrocarbon monoalcohols having 10 to about 18 carbon atoms. Long-chain hydrocarbon monoalcohols can be optionally substituted, for example, with groups such as one or more chlorine, bromine, trifluoromethyl, or phenyl groups. Representative long-chain hydrocarbon monoalcohols include 1-octanol, 1-decanol, 1-dodecanol, 1-tetradecanol, 1-hexadecanol, 1-octadecanol, and the like, and mixtures thereof. In some embodiments, the long-chain hydrocarbon monoalcohols have at least 12 carbon atoms and no greater than 16 or 14 carbon atoms.

The water soluble protective coating may optionally comprise one or more additives including, but not limited to, surfactants, fillers, compatibilizers, processing aids, detackifiers, slip agents, and antimicrobial agents.

Since the water soluble protective coating is soluble or dispersible in water, the protective coating can be applied as a dilute aqueous coating composition that optionally contains an organic cosolvent. The liquid solvent of the protective coating typically contains at least 85 percent by weight of water. It may contain a higher amount of water such as, for example, at least 90, 95, or even at least 99 percent by weight of water or more. The aqueous liquid medium may comprise a mixture of water and one or more water-soluble organic cosolvent(s), in amounts such that the aqueous liquid medium forms a single phase. Examples of water-soluble organic cosolvents include methanol, ethanol, isopropanol, 2-methoxyethanol, 3-methoxypropanol, 1-methoxy-2-propanol, tetrahydrofuran, and ketone or ester solvents. In some embodiments, the amount of organic cosolvent does not exceed 15 wt-% of the total liquids of the coating composition.

The water soluble protective coating can be applied to the adhesive layer of the sheeting by various techniques, as known in the art. In one embodiment, the coating is applied by a method wherein the coating apparatus does not contact the adhesive layer such as dip coating or spray coating. The coating weight of the water soluble protective coating can vary. After drying, the coating weight of the water soluble protective coating (i.e. water soluble polymer and polymeric additive in the absence of aqueous solvent) is at least 5, 10 or 15 grams/m² and typically no greater than 50, or 40, or 30, or 20 grams/m².

As used herein sheeting refers to thin, large surface area articles that can be provided as a roll-good of individual sheets that may be rectangular in shape. Roll-goods of sheeting typically have a width of at least 50, 75, or 100 cm and a length of 10, 20, or 30 meters. The sheets typically have the same width as the roll. However, the length can be less than 10, 9, 8, 7, 6, 5, 4, 3, 2, or 1 meter. The thickness of the sheeting substrate is typically at least 25, 50, or 75 microns and no greater than 500, 250, or 200 microns.

Suitable materials for use as the sheeting substrate include various thermoplastic or thermosetting polymeric films. Representative examples of polymeric films for use as the substrate include single and multi-layer constructions of acrylic-containing films (e.g. poly(methyl) methacrylate [PMMA]), poly(vinyl chloride)-containing films, (e.g., vinyl, polymeric materialized vinyl, reinforced vinyl, vinyl/acrylic blends), poly(vinyl fluoride) containing films, urethane-containing films, melamine-containing films, polyvinyl butyral-containing films, polyolefin-containing films, polyester-containing films (e.g. polyethylene terephthalate) and polycarbonate-containing films. Further, the substrate may comprise copolymers of such polymeric species.

In a favored embodiment, the substrate is a single or multi-layered film having a printed image reception layer (on exposed surface 14 or buried surface 16). The image reception layer is selected based on the intended ink and printing method. A variety of print methods have been employed for imaging sheeting materials. Commonly employed print methods include gravure, off-set, flexographic, lithographic, electrographic, electrophotographic (including laser printing and xerography), ion deposition (also referred to as electron beam imaging [EBI]), magnetographics, (e.g. piezo) ink jet printing, screen printing and thermal mass transfer. More detailed information concerning such methods is available in standard printing textbooks.

Depending on the choice of polymeric material and thickness of the substrate, the substrate and article may be rigid, but typically is flexible. “Flexible” refers to the physical property wherein the substrate or article (or material having a thickness of 50 microns) can be creased at 25° C. without any visible cracks in the substrate.

The substrate and sheeting article together with the adhesive may be clear, translucent, or opaque. Further, the substrate and article may be colorless, comprise a solid color or comprise a pattern of colors. Additionally, the substrate and article may be transmissive, reflective, or retroreflective. The reflective sheeting may comprise glass or ceramic beads at least partially embedded in a binder. Retroreflective sheeting generally comprises retroreflective glass or ceramic beads partially embedded in a binder layer or retroreflective cube corner elements. Retroreflective sheeting is utilized for signs and pavement markings.

In some embodiments, the substrate of the sheeting is a light transmissive film exhibiting a transmission of visible light (i.e. 400 to 700 nm) of at least 80, 90, 95% or greater. The inclusion of the printed graphic or (e.g. printed) decorative pattern can reduce the transmission. In some embodiments, the sheeting in combination with a printed graphic or (e.g. printed) decorative pattern is opaque or has a transmission of less than 50, 40, 30, 20, or 10%. In other embodiments, the sheeting in combination with a printed graphic or (e.g. printed) decorative has a transmission of at least 50, 60, 70, 80, or 90%. The transmission can be measured with various known techniques. As used herein, the on-axis transmission was measured with an instrument commercially available from BYK Gardner under the trade designation “Haze-Guard Plus (catalog #4725).

In some embodiments, the sheeting is suitable for decorative and protective window films including fenestration products (i.e., products that fill openings in a building, such as windows, doors, skylights, or curtain walls, e.g., that are designed to permit the passage of light. Commercially available films include “3M™ Fasara Glass Finishes” and “3M™ Dichoric Glass Finishes”.

In other embodiments, the sheeting is a commercial graphic sheeting suitable for advertising, promotional, and corporate identity. Such films typically comprise a pressure sensitive adhesive on the non-viewing surface in order that the films can be adhered to a target surface such as a billboard, building, awning, floor, automobile or mass transit vehicle including busses, trains and airplanes, etc. Commercially available films typically used for signage and commercial graphic include those available from 3M under the trade designations “Panaflex”, “Nomad”, “Scotchcal”, “Scotchlite”, “Controltac”, and “Controltac Plus”.

A wide variety of pressure sensitive adhesive are suitable for the sheeting article. Examples of suitable classes of pressure sensitive adhesives include those based on natural rubbers, synthetic rubbers, styrene block copolymers, polyvinyl ethers, acrylics, poly-a-olefins, silicones, urethanes or ureas.

Pressure-sensitive adhesives provide a suitable balance of tack, peel adhesion, and shear holding power. The modulus of the pressure sensitive adhesive at the application temperature, typically room temperature 25° C., is less than 3×10⁶ dynes/cm at a frequency of 1 Hz. In some embodiments, the modulus of the pressure sensitive adhesive at the application temperature, typically room temperature (25° C.), is less than 2×10⁶ dynes/cm or 1×10⁶ dynes/cm at a frequency of 1 Hz. Further, in some embodiments, the pressure sensitive adhesive is optically transparent (transmission of at least 95, 96, 97, 98, or 99% for visible light and L* no greater than 95 according to ASTM-E1164-07).

In favored embodiments, the adhesive is an acrylic adhesive comprising a (meth)acrylic polymer prepared from one or more monomers such as a (meth)acrylic ester monomers (also referred to as (meth)acrylate acid ester monomers and alkyl(meth)acrylate monomers) optionally in combination with one or more other monomers such as acid-functional ethylenically unsaturated monomers, non-acid-functional polar monomers, and vinyl monomers.

The term “alkyl” includes straight-chained, branched, and cyclic alkyl groups and includes both unsubstituted and substituted alkyl groups. Unless otherwise indicated, the alkyl groups typically contain from 1 to 20 carbon atoms. Examples of “alkyl” as used herein include, but are not limited to, methyl, ethyl, n-propyl, n-butyl, n-pentyl, isobutyl, t-butyl, isopropyl, n-octyl, 2-octyl, n-heptyl, ethylhexyl, cyclopentyl, cyclohexyl, cycloheptyl, adamantyl, and norbornyl, and the like. Unless otherwise noted, alkyl groups may be mono- or polyvalent.

The (meth)acrylic polymer comprises one or more (meth)acrylate ester monomers derived from a (e.g. non-tertiary) alcohol containing from 1 to 14 carbon atoms and preferably an average of from 4 to 12 carbon atoms.

Examples of monomers include the esters of either acrylic acid or methacrylic acid with non-tertiary alcohols such as ethanol, 1-propanol, 2-propanol, 1-butanol, 2-butanol, 1-pentanol, 2-pentanol, 3-pentanol, 2-methyl-1-butanol, 3-methyl-l-butanol, 1-hexanol, 2-hexanol, 2-methyl-l-pentanol, 3-methyl-1-pentanol, 2-ethyl-1-butanol, 3,5,5-trimethyl-1-hexanol, 3-heptanol, 1-octanol, 2-octanol, isooctylalcohol, 2-ethyl-1-hexanol, 1-decanol, 2-propylheptanol, 1-dodecanol, 1-tridecanol, 1-tetradecanol, and the like. In some embodiments, a preferred (meth)acrylate ester monomer is the ester of (meth)acrylic acid with isooctyl alcohol. In some favored embodiments, the monomer is the ester of (meth)acrylic acid with an alcohol derived from a renewable source.

The (e.g. pressure sensitive) adhesive (e.g. (meth)acrylic polymer and/or solvent monomer) comprises one or more low T_{g} (meth)acrylate monomers, having a T_{g} no greater than 10° C. when reacted to form a homopolymer. In some embodiments, the low T_{g} monomers have a glass transition temperature (T_{g}) of no greater than 0° C., no greater than −5° C., or no greater than −10° C. when reacted to form a homopolymer. The T_{g} of these homopolymers is often greater than or equal to −80° C., greater than or equal to −70° C., greater than or equal to −60° C., or greater than or equal to −50° C. The T_{g} of these homopolymers can be, for example, in the range of −80° C. to 20° C., −70° C. to 10° C., −60° C. to 0° C., or −60° C. to −10° C.

The low T_{g} monomer may have the formula

H₂C═CR1C(O)OR⁸

wherein R1 is H or methyl and R⁸ is an alkyl with 1 to 22 carbons or a heteroalkyl with 2 to 20 carbons and 1 to 6 heteroatoms selected from oxygen or sulfur. The alkyl or heteroalkyl group can be linear, branched, cyclic, or a combination thereof.

Exemplary low T_{g} monomers include for example ethyl acrylate, n-propyl acrylate, n-butyl acrylate, isobutyl acrylate, t-butyl acrylate, n-pentyl acrylate, isoamyl acrylate, n-hexyl acrylate, 2-methylbutyl acrylate, 2-ethylhexyl acrylate, 4-methyl-2-pentyl acrylate, n-octyl acrylate, 2-octyl acrylate, isooctyl acrylate, isononyl acrylate, decyl acrylate, isodecyl acrylate, lauryl acrylate, isotridecyl acrylate, octadecyl acrylate, and dodecyl acrylate.

Low Tg heteroalkyl acrylate monomers include, but are not limited to, 2-methoxyethyl acrylate and 2-ethoxyethyl acrylate.

In some embodiments, the (e.g. pressure sensitive) adhesive (e.g. (meth)acrylic polymer and/or solvent monomer) comprises low T_{g} monomer(s) having an alkyl group with 6 to 20 carbon atoms. In some embodiments, the low T_{g} monomer has an alkyl group with 7 or 8 carbon atoms. Exemplary monomers include, but are not limited to, 2-ethylhexyl methacrylate, isooctyl methacrylate, n-octyl methacrylate, 2-octyl methacrylate, isodecyl methacrylate, and lauryl methacrylate. Likewise, some heteroalkyl methacrylates such as 2-ethoxy ethyl methacrylate can also be used.

In some embodiments, the (e.g. pressure sensitive) adhesive (e.g. (meth)acrylic polymer and/or solvent monomer) comprises a high T_{g} monomer, having a T_{g} greater than 10° C. and typically of at least 15° C., 20° C. or 25° C., and preferably at least 50° C. Suitable high Tg monomers include, for example, t-butyl acrylate, methyl methacrylate, ethyl methacrylate, isopropyl methacrylate, n-butyl methacrylate, isobutyl methacrylate, s-butyl methacrylate, t-butyl methacrylate, stearyl methacrylate, phenyl methacrylate, cyclohexyl methacrylate, isobornyl acrylate, isobornyl methacrylate, norbornyl (meth)acrylate, benzyl methacrylate, 3,3,5 trimethylcyclohexyl acrylate, cyclohexyl acrylate, N-octyl acrylamide, and propyl methacrylate or combinations.

In some embodiments, the (meth)acrylic polymer is a homopolymer. In other embodiments, the (meth)acrylic polymer is a copolymer. Unless specified otherwise, the term polymer refers to both a homopolymer and copolymer.

The T_{g} of the copolymer may be estimated by use of the Fox equation, based on the T_{g}s of the constituent monomers and the weight percent thereof.

The alkyl (meth)acrylate monomers are typically present in the (meth)acrylic polymer in an amount of at least 85, 86, 87, 88, 89, or 90 up to 95, 96, 97, 98, or 99 parts by weight, based on 100 parts by weight of the total monomer. When high T_{g} monomers are included in a pressure sensitive adhesive, the adhesive may include at least 5, 10, 15, 20, to 30 parts by weight of such high T_{g} monomer(s). In some embodiments, the pressure sensitive adhesive composition comprises at least 50, 55, 60, 65, 70, 75, 80, 85, or 90 parts by weight, based on 100 parts by weight of the total monomer of one or more low Tg monomers. For embodied methods wherein the adhesive is not a pressure sensitive adhesive, the adhesive may comprise 50, 55, 60, 65, 70, 75, 80, 85, or 90 parts by weight, based on 100 parts by weight of the total monomer of one or more high T_{g} monomers.

The (meth)acrylic polymer may optionally comprise an acid functional monomer (a subset of high T_{g} monomers), where the acid functional group may be an acid per se, such as a carboxylic acid, or a portion may be salt thereof, such as an alkali metal carboxylate. Useful acid functional monomers include, but are not limited to, those selected from ethylenically unsaturated carboxylic acids, ethylenically unsaturated sulfonic acids, ethylenically unsaturated phosphonic acids, and mixtures thereof. Examples of such compounds include those selected from acrylic acid, methacrylic acid, itaconic acid, fumaric acid, crotonic acid, citraconic acid, maleic acid, oleic acid, β-carboxyethyl (meth)acrylate, 2-sulfoethyl methacrylate, styrene sulfonic acid, 2-acrylamido-2-methylpropanesulfonic acid, vinylphosphonic acid, and mixtures thereof.

Due to their availability, acid functional monomers are generally selected from ethylenically unsaturated carboxylic acids, i.e. (meth)acrylic acids. When even stronger acids are desired, acidic monomers include the ethylenically unsaturated sulfonic acids and ethylenically unsaturated phosphonic acids. The acid functional monomer is generally used in amounts of 0.5 to 15 parts by weight, preferably 0.5 to 10 parts by weight, based on 100 parts by weight total monomer.

The (meth)acrylic copolymer may optionally comprise other monomers such as a non-acid-functional polar monomer.

Representative examples of suitable polar monomers include but are not limited to 2-hydroxyethyl (meth)acrylate; N-vinylpyrrolidone; N-vinylcaprolactam; acrylamide; mono- or di-N-alkyl substituted acrylamide; t-butyl acrylamide; dimethylaminoethyl acrylamide; N-octyl acrylamide; poly(alkoxyalkyl) (meth)acrylates including 2-(2-ethoxyethoxy)ethyl (meth)acrylate, 2-ethoxyethyl (meth)acrylate, 2-methoxyethoxyethyl (meth)acrylate, 2-methoxyethyl methacrylate, polyethylene glycol mono(meth)acrylates; alkyl vinyl ethers, including vinyl methyl ether; and mixtures thereof. Preferred polar monomers include those selected from the group consisting of 2-hydroxyethyl (meth)acrylate and N-vinylpyrrolidinone. The non-acid-functional polar monomer may be present in amounts of 0 to 10 parts by weight, or 0.5 to 5 parts by weight, based on 100 parts by weight total monomer.

When used, vinyl monomers useful in the (meth)acrylate polymer include vinyl esters (e.g., vinyl acetate and vinyl propionate), styrene, substituted styrene (e.g., a-methyl styrene), vinyl halide, and mixtures thereof. As used herein vinyl monomers are exclusive of acid functional monomers, acrylate ester monomers and polar monomers. Such vinyl monomers are generally used at 0 to 5 parts by weight, preferably 1 to 5 parts by weight, based on 100 parts by weight total monomer.

The pressure-sensitive adhesives may optionally contain one or more conventional additives. Preferred additives include tackifiers, plasticizers, dyes, antioxidants, UV stabilizers, and (e.g. inorganic) fillers such as (e.g. fumed) silica and glass bubbles.

In some embodiments no tackifier is used. When tackifiers are used, the concentration is typically at least 5 or 10 wt-% of the (e.g. cured) adhesive composition. In some embodiments, the tackifier concentration is no greater than 30 25, or 20 wt-%.

Various types of tackifiers include phenol modified terpenes and rosin esters such as glycerol esters of rosin and pentaerythritol esters of rosin that are available under the trade designations “Nuroz”, “Nutac” (Newport Industries), “Permalyn”, “Staybelite”, “Foral” (Eastman). Also available are hydrocarbon resin tackifiers that typically come from C5 and C9 monomers by products of naphtha cracking and are available under the trade names “Piccotac”, “Eastotac”, “Regalrez”, “Regalite”

(Eastman), “Arkon” (Arakawa), “Norsolene”, “Wingtack” (Cray Valley), “Nevtack”, LX (Neville Chemical Co.), “Hikotac”, “Hikorez” (Kolon Chemical), “Novares” (Rutgers Nev.), “Quintone”(Zeon), “Escorez” (Exxonmobile Chemical), “Nures”, and “H-Rez” (Newport Industries). Of these, glycerol esters of rosin and pentaerythritol esters of rosin, such as available under the trade designations “Nuroz”, “Nutac”, and “Foral” are considered biobased materials.

In general, the thickness of the adhesive layer ranges from 10 micrometers (about 0.4 mils) to 1500 micrometers (about 60 mils). More typically the adhesive is generally 25 micrometers (about 1 mil) to 50 micrometers (about 2 mils) thick.

The pressure sensitive adhesive layer may be applied to the (e.g. optical film or liner) substrate utilizing various techniques including knife coating, roll coating, gravure coating, rod coating, curtain coating, and air knife coating. The adhesive may also be printed by known methods such as screen printing or inkjet printing. The coated solvent-based adhesive is dried to remove the solvent. Typically, the coated solvent-based adhesive is subjected to elevated temperatures, such as those supplied by an oven, to expedite drying of the adhesive. Solventless processes may also be suitable for application of the pressure sensitive. For example, the pressure sensitive adhesive may be applied via a hot melt coating process or may be applied as a 100% solids formulation followed by radiation curing. The radiation curable pressure sensitive adhesives are exposed to a source of actinic (e.g. ultraviolet) radiation.

The pressure sensitive adhesive layer may be continuous or discontinuous. Discontinuous adhesive layers can have a variety of configurations, including random distributions or patterned distributions. Among suitable patterned distributions are stripes (either straight or wavy) and dots (in a variety of shapes and sizes). Additionally, the pressure sensitive adhesive layer, whether continuous or discontinuous, can be a segmented adhesive layer. A segmented adhesive layer is one that contains segments which contain different adhesive compositions. A segmented adhesive layer is different from an adhesive blend, in that in an adhesive blend a single adhesive composition comprises a mixture of different adhesive components. In a segmented adhesive layer, different segments of the adhesive layer comprise different compositions. The discontinuous adhesive layer or segmented adhesive layer can be prepared through the use of a variety of different coating techniques, for example, stripe coating or a variety of different printing techniques.

To aid in the application of the sheeting, it is typically desirable to utilize a repositionable pressure sensitive adhesive.

As described in U.S. Pat. No. 7,279,057, the use of a water-soluble protective coating aids in repositionability since the water soluble protective coating reduces the adhesive of the underlying pressure sensitive adhesive layer until it is removed with an aqueous solution.

In another embodiment, the adhesive layer may comprise a microstructured surface, such as described in WO 94/00525; incorporated herein by reference. Such microstructured surface comprising a plurality of pegs (optionally containing one or more beads) substantially distributed and protruding outwardly from the adhesive layer wherein the pegs have essentially flat tops that comprise less than 25% of the total surface contact area of the adhesive layer, and have a height of at least 15 micrometers. WO 98/29516 (Sher et al.) reports an adhesive having a microstructured topography prepared from contacting a microembossed pattern to a layer of adhesive. The topography of the microstructured adhesive surface aids the repositionability of the adhesive.

In another embodiment, the adhesive layer comprises a microstructured surface having a plurality of recessed interconnecting channels such as described in WO 00/69985 and WO 02/074877; incorporated herein by reference. The shape of the channels may have a V-shaped, U-shaped, rectangular or trapezoidal cross section. Further, the channels may comprise a volume of at least 1×10³ μm² per any 500 μm³diameter circular area in the adhesive. The channels are utilized to create exit pathways for fluid egress to a periphery of the adhesive layer of the finishing film. The channels are substantially undetectable after final application of the sheeting to a target surface. A typical article 10 of this type is shown in FIG. 2A (FIG. 1 from WO 02/074877) that includes a (e.g. film) substrate 12 having opposed surfaces 14 and 16. The surface 14 of the (e.g. film) substrate 12 is imaged to form a graphic 13. A pressure sensitive adhesive layer 18 is bonded to the surface 16 of the (e.g. film) substrate 12. The pressure sensitive adhesive layer 18 includes a surface 20 that can be bonded to a (e.g. target) surface or substrate (such as a window). The pressure sensitive adhesive layer 18 includes structures 22 that define a network of channels 24. A release liner 26 is releasably attached to the pressure sensitive adhesive layer 18. The release liner 26 includes protrusions 28 that form the corresponding channels 24 and structures 22 in the pressure sensitive adhesive layer 18. The release liner 26, shown in a partially removed state, is fully detachable when pulled in the direction of arrow A and is present prior to the application of the water soluble protective coating 30 as shown in FIG. 2B.

In some embodiments, the presence of the water soluble protective coating maintains the (e.g. recessed channel) microstructures such that the product can be provided in the absence of a release liner.

The sheeting can be prepared by various (e.g. roll to roll) methods. In one embodiment the method comprises providing a substrate comprising a (e.g. microstructured) pressure sensitive adhesive layer wherein the release liner is covered by a removable release liner, such as shown in FIG. 2A. The method further comprises removing the release liner and applying the water soluble protective layer to the pressure sensitive adhesive layer, resulting in the sheeting depicted in FIG. 1 or FIG. 2B. In one embodiment, the water soluble protective layer is applied as an aqueous coating followed by drying the coating to remove the aqueous solvent. Thus, although the sheeting article is provided to the end user as a “linerless” article, a release liner can be used in the manufacture of the sheeting. The release liner can be reused or recycled.

Various other methods can be used to prepare the sheeting as known in the art, some of which are described in WO 2007/015264.

Various techniques can be used to applying the sheeting article, as described herein to a target surface (such as a window, building, or transportation vehicle). One embodied method of applying the sheeting article comprises providing a linerless sheeting article as described herein; applying an aqueous solution to remove the water soluble protective coating; contacting the pressure sensitive adhesive layer to a surface; and applying pressure to remove the aqueous solution between the pressure sensitive adhesive layer and the (e.g. target) surface. The aqueous solution may be tap water, optionally further comprising dishwashing soap or other surfactant. Typically a squeegee is used to apply pressure to the substrate surface on the sheeting. In doing so the aqueous solution is concurrently removed from the substrate surface and the interface between the pressure sensitive adhesive layer and the (e.g. target) surface.

### EXAMPLES

Objects and advantages of this invention are further illustrated by the following examples, but the particular materials and amounts thereof recited in these examples, as well as other conditions and details, should not be construed to unduly limit this invention. These examples are merely for illustrative purposes only and are not meant to be limiting on the scope of the appended claims.

### Materials

Unless otherwise noted, all parts, percentages, ratios, etc., in the examples and in the remainder of the specification are by weight. Unless otherwise noted, all chemicals were obtained from, or are available from, chemical suppliers such as Sigma-Aldrich Chemical Company, St. Louis, Mo.

FASARA FILM was obtained from 3M Company, St. Paul, Minn. under trade designation “3M™ Fasara™ Decorative Window Films”. Such film includes a 2 mil polyester substrate, a printed decorative pattern on the substrate, a 1 mil acrylic pressure sensitive adhesive layer, and a 1 mil release liner.

Polyvinyl alcohol (PVA, MW=9000-10000, and 80% hydrolysis) was obtained from Sigma-Aldrich Chemical Company, St. Louis, Mo.

Additive 1—oligomer described at column 28 of U.S. Pat. No. 8030430 (Preparation 4).

### Test Methods

### Method for Peel Adhesion Test

An IMASS SP2000 slip peel tester (obtained from IMASS Inc., Accord, Mass.) was used for all peel adhesion tests using standard stainless steel panels (obtained from ChemInstruments, Inc., Fairfield, Ohio). Tests were performed at 21° C. at 50% RH. A piece of 2.54 cm wide 3M Tape 610 was laminated to the sample films prepared in Examples and Comparative Examples described below with a 2 kg rubber roller, then peeled at an angle of 180° at the speed of 2.29 m per minute in 5 seconds. Typically, 3 measurements were made and the average reported.

The initial peel adhesion was tested as well as the peel adhesion after subjecting the sample to two different aging conditions: Aging Condition 1-40° C. at 75% relative humidity (RH) for 24 hours and Aging Condition 2-50° C. at 98% RH for 24 hours.

### Comparative Example 1

CE1 was the FASARA FILM with the release liner removed just prior to testing.

### Comparative Example 2

CE2 sample was prepared by coating the adhesive side of FASARA FILM with a 5 wt. % aqueous solution of PVA. To form the coating, the liner was removed from the FASARA FILM exposing the adhesive side and then applying a uniform coating of PVA solution on the adhesive side using a pneumatic spray gun. The coated films were then dried at room temperature for 24 hrs. The dry weight of the PVA coating on the FASARA FILM was 15-16 grams per square meter (gsm).

The initial peel adhesion was tested on some of the coated film. The coated film was also aged as previously described for aged peel adhesion.

Before testing the initial and aged peel adhesion, the water soluble protective coating was rinsed away under tap water for 5 minutes (the samples were kept at a distance of 25 cm below the faucet. The water temperature was 21° C. and the water flow was 1.32 kg/minute. The wet film was then subjected to peel testing.

### Example 3

EX3 sample was prepared in the same manner as CE2, except that the PVA coating solution contained 1 wt. % (with respect to the weight of PVA solids) of Additive 1.

The sample was tested in the same manner as previously described in Example CE2.

The peel adhesion test results were as follows:

| | Peel Adhesion |
|---|---|
| Example | (kgf) |
| CE1 (no protective coating) | 0.713 |
| | (initial w/o aging) |
| CE1 - Aging Condition 1 | 0.655 |
| CE1 - Aging Condition 2 | 0.720 |
| CE2 (PVA) | 0.540 |
| | (initial w/o aging) |
| CE2 - Aging Condition 1 | 0.054 |
| CE2 - Aging Condition 2 | 0.170 |
| EX3 (PVA & Additive 1) | 0.655 |
| | (initial w/o aging) |
| EX3 - Aging Condition 1 | 0.734 |
| EX3 - Aging Condition 2 | 0.830 |

The FTIR spectra of CE1 before and after Aging Condition 1 were compared using a FTIR spectrometer (Nicolet 6700 FTIR, Thermo Fisher Scientific, Madison, Wis.). The FTIR spectra overlapped completely indicating no recognizable differences between the two samples.

The FTIR spectra of CE2 before and after Aging Condition 1 were also compared using FTIR. The FTIR spectra of the initial (unaged) EX2 had an absorption peak at 3500 cm⁻¹ (corresponding to absorbance by water) of about 0.100 and an absorption peak at 3500 cm⁻¹ of about 0.125 after Aging Condition 1, an increase of 0.025.

The FTIR spectra of EX3 before and after Aging Condition 1 were also compared using FTIR. The aged sample exhibited an increase of 0.01 for the absorption peak at 3500 cm⁻¹.

### Comparative Examples 4 (CE4)

CE4 was 3M Scotchcal™ Film containing acrylate adhesive (IOA/AA=94/6; 50% rosin ester tackifier) with air-bleed microstructured channels.

### Comparative Examples 5 (CE5)

CE5 sample was prepared by coating the adhesive side of 3M Scotchcal™ Film with a 5 wt. % aqueous solution of PVA. To form the coating, the liner was removed from the 3M Scotchcal™ Film exposing the adhesive side and then applying a uniform coating of PVA solution on the adhesive side using a pneumatic spray gun. The coated films were then dried at room temperature for 24 hrs. The dry weight of the PVA coating was maintained at 15-16 grams per square meter.

### Example 6

EX6 sample was prepared in the same manner as CE5, except that the PVA coating solution further 1 wt. % (with respect to the weight of PVA solids) of Additive 1.

CE4, CE5, and EX6 were aged for 24 hours at 40° C. at 70% RH. After aging, the release liner was removed from CE4 and the water soluble protective coating was rinsed away from CE5 and EX6 in the same manner as previously described.

The peel adhesion test results were as follows:

| | Peel Adhesion |
|---|---|
| Examples | (kgf) |
| CE4 - (no protective coating) | 0.54 |
| CE5 - (PVA) | 0.50 |
| Ex 6 - (PVA & Additive 1) | 0.54 |

1. A linerless sheeting article comprising:
a substrate;
a pressure sensitive adhesive layer disposed on the substrate,
a water soluble protective layer disposed on the pressure sensitive adhesive layer wherein the water soluble protective layer comprises at least 50 wt-% solids of a water soluble polymer and a polymer additive comprising a fluorinated-group, a silane group, or a combination thereof.

2. The linerless sheeting article of claim 1 wherein the polymer additive is present in an amount no greater than 5 wt-% solids.

3. The linerless sheeting article of claim 1 wherein the polymer additive is an oligomer.

4. The linerless sheeting article of claim 1 wherein the polymer additive comprises a perfluoroalkyl or perfluoropolyether group having no greater than 6 fluorine atoms.

5. The linerless sheeting article of claim 1 wherein the polymer additive comprises a silane group having the formula —R¹—Si—(Y)₃ wherein R¹ is a divalent alkylene or heteroalkylene group and Y is an alkoxy group.

6. The linerless sheeting article of claim 1 wherein the polymer additive is the reaction product of a diol, monoalcohol, or acid having a water-solubilizing group.

7. The linerless sheeting article of claim 1 wherein the water soluble polymer comprises polyvinyl alcohol.

8. The linerless sheeting article of claim 1 wherein the water soluble polymer has a molecular weight ranging from about 5,000 to 50,000 g/mole.

9. The linerless sheeting article of claim 1 wherein the pressure sensitive adhesive comprises polymerized units derived from one or more alkyl(meth)acrylate monomer(s).

10. The linerless sheeting article of claim 1 wherein the pressure sensitive adhesive comprises at least 50, 55, 60, 65, or 70 wt-% of polymerized units of alkyl (meth)acrylates comprising 6 to 20 carbon atoms.

11. The linerless sheeting article of claim 9 wherein the acrylic adhesive further comprises a tackifying resin.

12. The linerless sheeting article of claim 1 wherein upon removing the water soluble protective layer, the initial peel adhesion of the adhesive exhibits a decrease of no greater than 10%.

13. The linerless sheeting article of claim 1 wherein upon removing the water soluble protective layer, the adhesive layer exhibits an increase in an absorption peak nearest 3500 cm⁻¹ ranging from zero to no greater than 0.015.

14. The linerless sheeting article of claim 1 wherein the substrate is a polymeric film.

15. The linerless sheeting article of claim 14 wherein the polymeric film and pressure sensitive adhesive are light transmissible.

16. The linerless sheeting article of claim 1 wherein the sheeting article is a window film or a commercial graphic sheeting.

17. The sheeting article of claim 1 wherein the substrate further comprises a printed graphic, decorative printed pattern, or a combination thereof.

18. A method of making a sheeting article comprising: providing a sheeting article comprising
a substrate,
a pressure sensitive adhesive layer disposed on the substrate, and
a release liner disposed on the pressure sensitive adhesive layer, removing the release liner; applying an aqueous coating composition comprising a water soluble polymer and a polymer additive comprising a fluorinated-group, a silane group, or a combination thereof; drying the aqueous coating composition.

19. (canceled)

20. A method of applying a sheeting article comprising:
providing a linerless sheeting article according to claim 1;
applying water or an aqueous solution to remove the water soluble protective coating;
contacting the pressure sensitive adhesive layer to a surface; and
applying pressure to remove the water or aqueous solution between the pressure sensitive adhesive layer and the surface.
